(19) United States
(12) Patent Application Publication
(10) Pub. No.: US 2009/0029018 A1
(43) Pub. Date: Jan. 29, 2009

(54) METHOD AND APPARATUS FOR PROCESSING CONFECTIONERY PRODUCTS

(75) Inventors: Cesar Elejalde, Randolph, NJ (US); Bharat Jani, East Brunswick, NJ (US)

Correspondence Address: HOFFMANN & BARON, LLP, 6900 JERICHO TURNPIKE, SYOSSET, NY, 11791, US

(73) Assignee: CADBURY ADAMS USA LLC, Parsippany, NJ (US)

(21) Appl. No.: 12/180,207

(22) Filed: Jul. 25, 2008

Related U.S. Application Data
(60) Provisional application No. 60/952,255, filed on Jul. 27, 2007.

(51) Int. Cl. A23G 3/54; A23G 1/54

(52) U.S. Cl. 426/284; 426/514; 425/113; 425/112

(57) ABSTRACT

The present invention relates to an apparatus and method for producing a center-filled consumable product. The apparatus and method include an extruder, which extrudes a continuous tubular rope of consumable product, a rope sizer, a relaxation conveyor, and a cutting apparatus for forming individual pieces of center-filled consumable products.

### CROSS-REFERENCE TO RELATED APPLICATIONS

This application claims priority to U.S. Provisional Application No. 60/952,255 filed Jul. 27, 2007; the contents of which are incorporated herein by reference.

### FIELD OF THE INVENTION

The present invention relates generally to a method and an apparatus for forming individual center-filled confectionery pieces from a continuous rope or strand. More particularly, the present invention relates to a method and apparatus for forming such center-filled confectionery pieces including the use of a rope sizer and/or a relaxation conveyor.

### BACKGROUND OF THE INVENTION

Center-filled confectionery products are well known. These products typically have a solid or semi-solid exterior shell and a soft liquid or semi-liquid center. One well known example of such center-filled confectionery products are liquid-filled gum pieces.

One typical process for forming such center-filled confectionery products is to extrude a continuous rope or strand into a hollow-tubular configuration. The hollow rope is then filled with the soft or liquid confectionery product. Thereafter, the rope is processed in a longitudinally continuous fashion so as to size the rope and pass the rope between dies which continuously cut the rope into individual center-filled pieces. The process for forming such pieces and an apparatus for affecting the process is more fully shown and described in U.S. Pat. Nos. 6,838,098; 6,558,727; 6,472,001 and 6,284,291. Each of these patents is incorporated by reference herein for all purposes.

While these processes and similar processes serve adequately to form center-filled confectionery products such as center-filled gum, the speed and efficiency of the process is limited due to the fact that the rope is formed and processed in a linear fashion. In a typical process, the rope is extruded at a first diameter and then must be reduced to a smaller diameter by using rollers or another similar apparatus. The rope, being a rubbery material, has a tendency to longitudinally contract after it is extruded, due to natural forces, this is comparable to a relaxation. The faster the product is extruded and reduced, the more likely it is to relax. With center filled products any longitudinal contraction after cutting may cause the center fill material to leak out of the product. Thus, there is a need to allow for an efficient process to produce gum, while avoiding center-fill leakage after cutting.

It is desirable to provide a process and apparatus which more efficiently processes ropes of confectionery material, while avoiding the problems associated with shrinkage and/or leakage of the center-filled confectionery products.

### SUMMARY OF THE INVENTION

The present invention provides an apparatus which prepares center-filled consumable products, including chewing gums and other confectionery products. In one aspect, the invention includes an extruder, which extrudes a continuous tubular rope of consumable product, a rope sizer, a relaxation conveyor and a cutting apparatus.

In another aspect of the invention, there is provided a method for preparing center-filled consumable products, including the steps of extruding a continuous tubular rope of the consumable product, passing the rope through a rope sizer, passing the rope along a relaxation conveyor, and passing the rope into a cutting apparatus, wherein the cutting apparatus cuts the rope into individual pieces.

In another aspect of the invention, there is provided a method of forming a center fill consumable product including the steps of extruding a continuous tubular rope of consumable product, reducing the diameter of the extruded continuous tubular rope, transporting the reduced diameter extruded rope along a movable relaxation conveyor, and cutting the extruded continuous rope into individual pieces of consumable product

In another aspect of the invention, there is provided a method for forming a center-filled consumable product including the steps of extruding a continuous tubular rope of consumable product, passing the extruded rope through a rope sizer, and passing the rope into a cutting apparatus, where the cutting apparatus cuts the rope into individual pieces.

In a further aspect of the invention, there is provided a method for forming a center-filled consumable product including the steps of extruding a continuous tubular rope of consumable product, passing the rope along a relaxation conveyor, and passing the rope into a cutting apparatus, where the cutting apparatus cuts the rope into individual pieces.

In another aspect of the invention, there is an apparatus for preparing a center-filled consumable product including a rope sizer for reducing the diameter of the center-filled consumable product, the rope sizer including at least one pair of rollers.

In yet another aspect of the invention, there is an apparatus for preparing a center-filled consumable product including a relaxation conveyor for moving the center-filled consumable product.

### BRIEF DESCRIPTION OF THE DRAWINGS

FIG. 1 shows a schematic drawing of the center-filled consumable product forming apparatus as described herein.

FIG. 2 shows a side angle view of the rope sizing apparatus as described herein.

FIG. 3 shows a close-up view between a pair of rollers in the rope sizing apparatus as described herein.

FIG. 4 depicts an embodiment of the relaxation conveyor using a wave pattern to transport the rope along the conveyor.

FIG. 5 depicts an embodiment of the chain cutting apparatus as described herein.

### DETAILED DESCRIPTION OF THE PREFERRED EMBODIMENTS

The method and apparatus of the present invention may include an extruder for extruding continuous tubular ropes or strands of a first confectionery product. The extruder may be capable of extruding multiple tubular ropes of the first confectionery product, or it may extrude a single continuous rope. The ropes may be of any shape or size desired, including circular, rectangular, or any other formation desired. One such potential extruder is described in Applicant's co-pending patent application (entitled, “Method and Apparatus for Processing Multiple Confectionery Ropes”, Attorney Docket No. 1421-250P, Filed Jul. 27, 2007), which is incorporated by reference herein.

Embodiments described herein provide a multi-component composition which includes at least one center-fill region and a confectionery region. The individual confectionery piece may also include an outer coating or shell, which typically provides a crunchiness to the piece when initially chewed. The individual confectionery pieces may form a variety of shapes including pellet, tablet, ball, pillow, chunk, stick and slab, among others.

Center-filled confectionery pieces, such as center-filled gum, have a desired length of about 18 mm to about 20 mm, and a desired width of about 10 mm to about 12 mm. There is some degree of longitudinal shrinkage after the pieces have been cut. In a preferred embodiment, the degree of shrinkage is kept below about 10%, and preferably below at least 5%. Greater shrinkage has a higher tendency to cause the gum piece to break or crack, and thus leak the center-filled composition out of the product.

The extrusion may take place at any speed desired. The speed of the extrusion relates to the speed of the other elements of the invention, including sizing, relaxation, and cutting. Preferably, the rope is extruded at a speed of about 10 m/min to about 150 m/min, and more specifically at about 75 to about 100 m/min. For center-filled products, the center fill composition may be injected directly into the continuous tubular rope as it is being extruded. Alternatively, the center-fill composition may be injected into the continuous tubular rope at a point after extrusion, but before cutting.

### The Apparatus

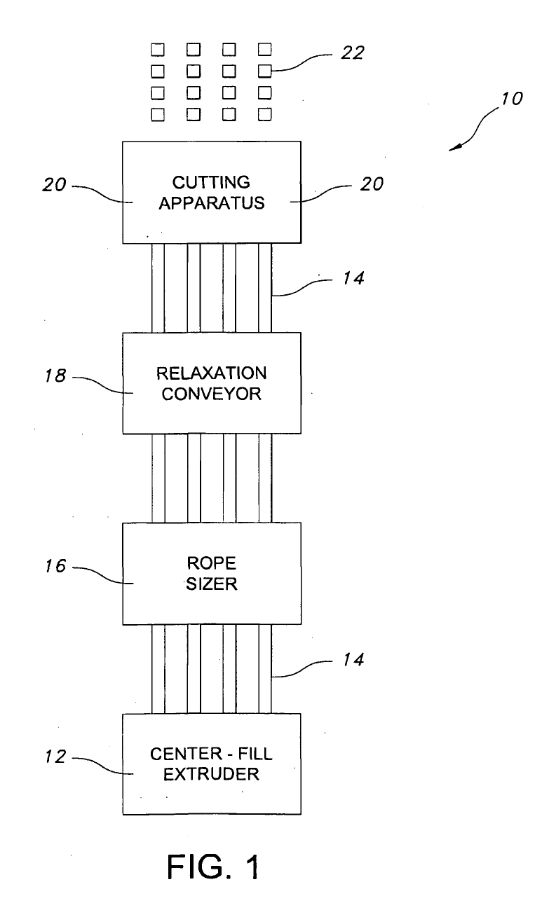

The apparatus 10, which may be used in conjunction with the present invention, is schematically shown in FIG. 1. The apparatus 10 may include an extruder 12, which may extrude one or more center-filled ropes 14. The extruder 12 may include one or more injection nozzles (not shown) for injecting liquid center-fill product into a hollow tubular rope(s) 14. The rope(s) 14 pass through a rope sizer 16, more fully described herein below, which reduces the size of the extruded rope(s) 14. The sized rope(s) 14 then pass to a relaxation conveyor 18, which will also be described in further detail hereinafter. The relaxation conveyor 18 allows the rope(s) 14 to relax. Thereafter, the rope(s) 14 are moved through a cutting apparatus 20, also more fully described below, which cuts the rope(s) 14 into individual pieces 22.

### The Rope Sizer

In one aspect, the present invention includes an apparatus to size the confectionery ropes after they are extruded. This apparatus is referred to as a “rope sizer.” In traditional extrusion, the tubular rope product is extruded at a size that is much thicker and larger than the desired end product. Thus, there is a need for a proper sizing apparatus, which extends the product, stretching it out so that it is the right thickness and size, while still maintaining the structural integrity of the rope, avoiding unwanted cracking and leakage of the center-fill composition. Rope sizers disclosed herein reduce the size of the extruded rope by any amount desired, and most preferably by about 30% to about 70%.

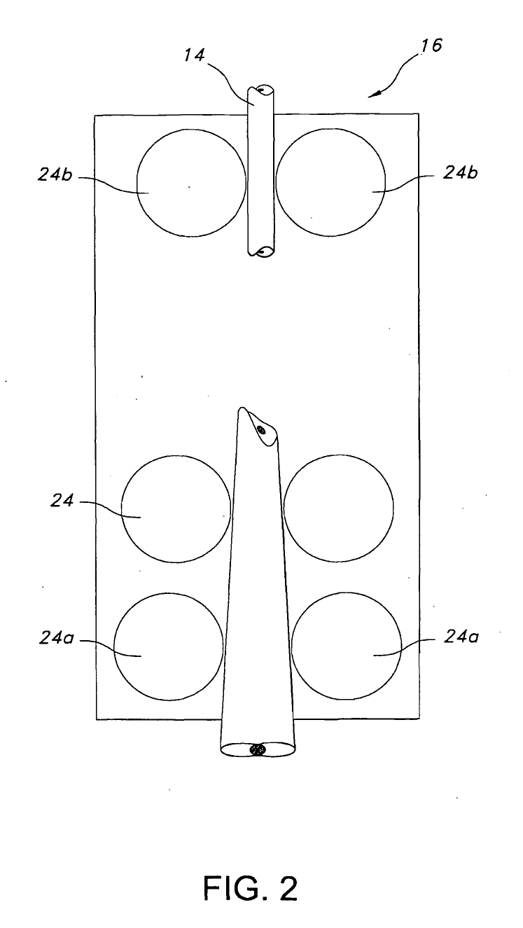

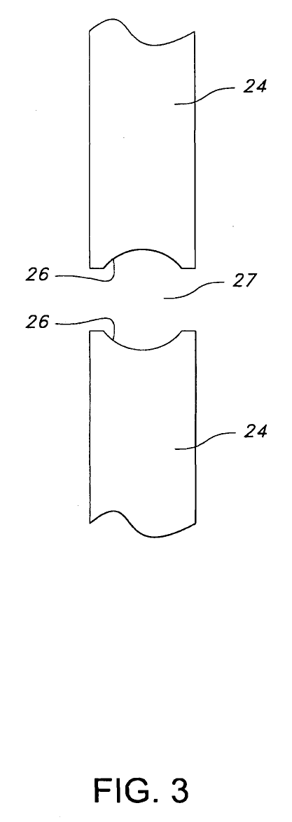

With reference to FIG. 2, the preferred rope sizer 16 has a plurality of pairs of rollers 24. The rollers 24 include a grooved surface 26 defining therebetween a passage 27 for accommodating rope 14 (shown in more detail in FIG. 3) designed to pull the rope product through. As the rope is fed through the rope sizer 16, the speed of the rollers 24 increases, so the last pair of rollers in the rope sizer 24b moves at a speed that is faster than the first pair of rollers in the rope sizer 24a. In addition, the grooved openings 26 get progressively smaller as the rope 14 is fed through the rope sizer 16, which helps to size the rope 14 properly. The proximal pair of rollers 24a, which is located at the point where the continuous rope 14 enters the rope sizer 16, has a larger grooved opening 26. The distal pair of rollers 24b, which is located at the point where the continuous rope 14 exits the rope sizer 16, has a smaller grooved opening 26. The pairs of rollers in between the proximal pair of rollers 24a and distal pair of rollers 24b have grooves 26 that are increasingly reduced in size. As the rope 14 is fed through the rope sizer 16, it is stretched and compressed until it has a thickness and diameter that allows properly-sized end products 22.

Thus, in one aspect of the invention, the pair of proximal rollers 24a has a large groove opening 26 and moves at a slow rate of speed. The pair of distal rollers 24b has a small groove opening 26 and moves at a fast rate of speed. The pairs of rollers 24 in between the proximal and distal pairs of rollers have increasingly smaller grooves, as well as increasing speed as the rope 14 travels through the rope sizer 16.

When the chewing gum ropes are extruded from the extruder 12, they may have an initial diameter of about 10 mm to about 40 mm, and more specifically from about 22 to about 26 mm. The pairs of rollers 24 have grooved openings 26 ranging from about 5 mm to about 50 mm in diameter, and more specifically from about 9 mm to about 36 mm in diameter.

In addition, the speed at which the rollers 24 move may vary. In one embodiment, manufacture of center-filled confectionery pieces, the rope 14 exits the rope sizer 16 at a velocity of at least 100 m/min; however it may exit the rope sizer 16 at any desired velocity from about 50 m/min to about 150 m/min. When the rope 14 first enters the rope sizer 16, it moves through the first pair of rollers 24a at a much slower velocity, generally from about 5 m/min to about 30 m/min. The pairs of rollers in between the proximal and distal ends feed the rope 14 through at varying velocities from about 20 m/min to about 140 m/min, with the last pair of rollers 24b moving the rope 14 at about 20 m/min to about 150 m/min.

Optionally, an anti-sticking agent may be used in conjunction with the rope sizer 16, to prevent the rope 14 from adhering to the rollers and getting stuck, which would decrease productivity. Generally, anti-sticking agents may be in the form of powders such as talc, calcium carbonate, or oils. For example, a fine mist of a food grade oil or an oil-based material may be sprayed on the rollers and material engaging surfaces of the rope sizer 16 before or as the rope of gum material 14 makes contact with the rollers 24. The oil temporarily reduces or eliminates the stickiness of the gum material and allows it to be sized without the need to cool the rollers with cooled air or nitrogen gas. In the alternative or in addition, it is also possible to apply the oil material directly on the rope of gum material 14. Suitable food grade oil or oil-based materials include, but are not limited to almond oil, apricot kernel oil, avocado oil, black cumin seed oil, borage seed oil, camellia oil, castor oil, cocoa oil, coconut oil, corn oil, cottonseed oil, evening primrose seed oil, grapeseed oil, hazelnut oil, hemp seed oil, jojoba oil, karanja seed oil, kukui nut oil, macadamia nut oil, meadowfoam seed oil, neem seed oil, olive oil, palm oil, peanut oil, pumpkin seed oil, rosehip seed oil, safflower oil, sea buckthorn oil, sesame seed oil, shea nut oil, soybean oil, sunflower oil, tamanu oil, vitamin E oil, and wheat germ oil. Synthetic oils may also be used.

In an embodiment, the apparatus 10 may be kept at a reduced temperature in order to prevent the confectionery material from sticking to the various parts described herein. For this purpose, cooled air or gas may be directed toward the rope sizer 16, the relaxation conveyor 18, the cutting apparatus 20, or any other part of the system in which the confectionery may potentially stick. The cooling air may flow directly at the surface of the parts to maintain it at a pre-determined temperature. In another embodiment, the parts themselves may be chilled, such as using a chilled extruder 12, a chilled rope sizer 16, a chilled relaxation conveyor 18 and/or a chilled cutting apparatus 20. Such chilling may be achieved through use of cooled fluid, such as water, liquid nitrogen, or other fluid. In an embodiment, the center fill material may be cooled upon exit from the filling apparatus. Using cooled center fill material has the effect of cooling the outer confectionery portion from the inside. The temperature of the parts is preferably maintained below −90.degree.F, although the actual temperature will vary with the material and production rate. The individual parts and/or the confectionery itself may be cooled at any temperature from about −100.degree.F to about 50.degree.F. In order to control costs of manufacture, the temperature should be just cold enough to support production, while inhibiting sticking of the confectionery.

### The Relaxation Conveyor

The method and apparatus of the present invention may optionally use a relaxation conveyor 18 to aid in the formation of the gum pieces. It is generally known that after stretching and extending confectionery ropes, specifically chewing gums, the rope 14 has a tendency to “spring back” and shrink to its normal size. By “relaxation conveyor,” it is contemplated that any mechanism to allow the tubular confectionery to “relax” and shrink prior to cutting may be used. The relaxation conveyor 18 provides a sufficient time delay between extrusion and cutting, to allow the confectionery rope 14 to get to a more stable form.

When multiple ropes are extruded, the use of a very wide table relaxation conveyor 18 is contemplated, but the use of multiple conveyors may also be used. For example, when extruding four continuous and simultaneous confectionery ropes 14, the ropes may be spread on the same relaxation conveyor 18, which is wide enough to encompass all four ropes. Optionally, multiple individual relaxation conveyors may be used for simultaneous multiple extrusions.

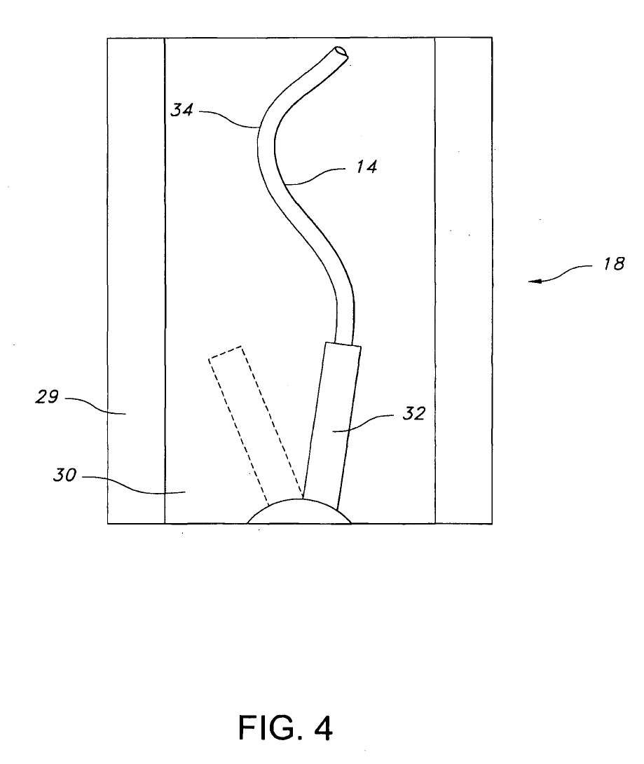

The relaxation conveyor 18 is schematically shown in FIG. 1. With reference to FIG. 4, one embodiment of the relaxation conveyor 18 includes a table 29 and a conveyor belt 30 that moves across table 29 at a speed related to the speed that the continuous rope 14 is fed through the rope sizer 16. The relaxation conveyor belt 30 should move at about half the velocity at which the continuous rope 14 moves as it exits the rope sizer 16. However, the relaxation conveyor belt 30 may move at any velocity desired, depending on the rate of shrinkage and the desired time delay between sizing and cutting. The relaxation conveyor 18 may be located at a point after the rope 14 has been sized, either from extruder 12 or through rope sizer 16, and at a point before the rope 14 is cut by the cutting apparatus 20.

Preferably, the relaxation conveyor 18 incorporates the use of an optional swing arm 32, which feeds the confectionery rope 14 onto the relaxation conveyor belt 30 in a non-linear path, such as a traditional wave 34 as depicted in FIG. 4. As the continuous rope 14 is fed through and out of the rope sizer 16, it is led along the swing arm 32 and deposited onto the conveyor belt 30. The swing arm 32 may optionally oscillate back and forth at varying speeds, allowing the continuous rope 14 to be deposited on the conveyor belt 30 in a wave pattern 34. The degree of oscillation affects the frequency and amplitude of the wave 34 on the conveyor belt 30, and thus affects the time delay between sizing and cutting.

Using a wave pattern 34 to deposit the rope onto the relaxation conveyor belt 30 allows a greater time delay prior to the rope being fed into the cutting apparatus 20, without having to use an extremely long relaxation conveyor 18. Without the use of a wave pattern 34, the continuous rope 14 relaxes for a shorter period of time. By allowing more time to pass, the continuous rope 14 has more time to “spring back” and shrink prior to being cut, giving more stability and less tendency to leak prematurely. Thus, the wave pattern 34 gives increased stability over a non-wave pattern relaxation.

Optionally, an anti-sticking agent or cooled component system as described above may be used with the relaxation conveyor 18. Incorporation of the anti-sticking agent and cooling system aids in reducing the tendency of the rope to get stuck as it travels along the conveyor 18.

As can be seen in Table 1 below, the chewing gum cores exhibit significantly less shrinkage when a relaxation conveyor 18 is used. For each of batches 1-3, four independent tests were run. The first three (labeled LC 50 m/min; LC 75 m/min; and LC 100 m/min) tests in each batch all used a relaxation conveyor 18 as described herein. The fourth test in each batch (labeled CC 60 m/min) did not use a relaxation conveyor 18 as described herein. As shown in Table 1, the tests using the relaxation conveyor 18 only experienced shrinkage of about 4.0% to about 7.25%. The tests without a relaxation conveyor 18 showed shrinkage of about 13.5%, about 15%, and about 16%.

TABLE 1
Shrinkage of Cores

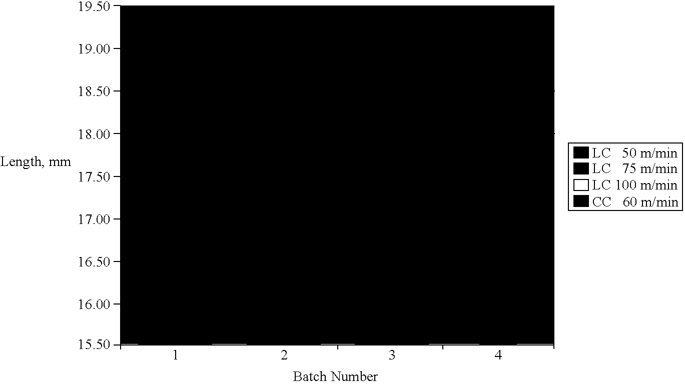

Similarly, as shown in Table 2 below, the chewing gum cores have a much greater length when a relaxation conveyor 18 as described herein is used. The same four tests were used for the three batches; with those tests using a relaxation conveyor 18 had final cores with lengths of about 19.2 mm to about 18.5 mm. Those tests without the relaxation conveyor 18 showed a final length of about 17.4 mm, 17.0 mm, and 16.8 mm.

TABLE 2
Length of Cores

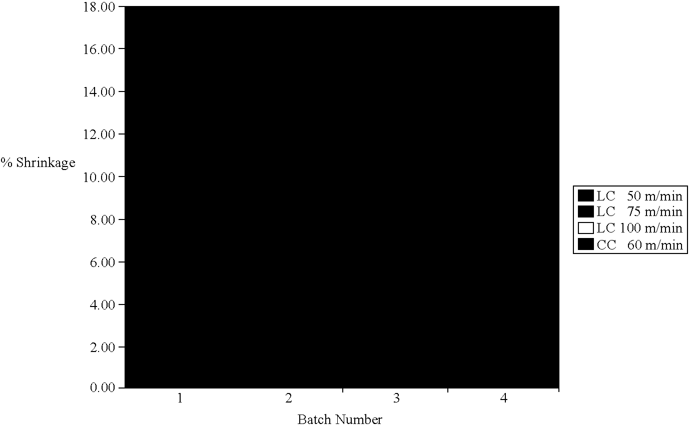

### The Cutting Apparatus

Any conventional means to cut the confectionery product into individual pieces can be used with the present invention. Preferably the invention uses a chain cutter apparatus 20 shown schematically in FIG. 1. Chain cutting apparatus 20 includes multiple dies to cut a plurality of individual pieces from the continuous filled rope 14. Such chain cutting apparatuses include those described in Applicant's co-pending PCT patent application (entitled “Chain cutter for continuously forming center-filled gum pieces”, Attorney Docket No. 1421-182 PCT, filed Jun. 29, 2007), which is hereby incorporated by reference herein.

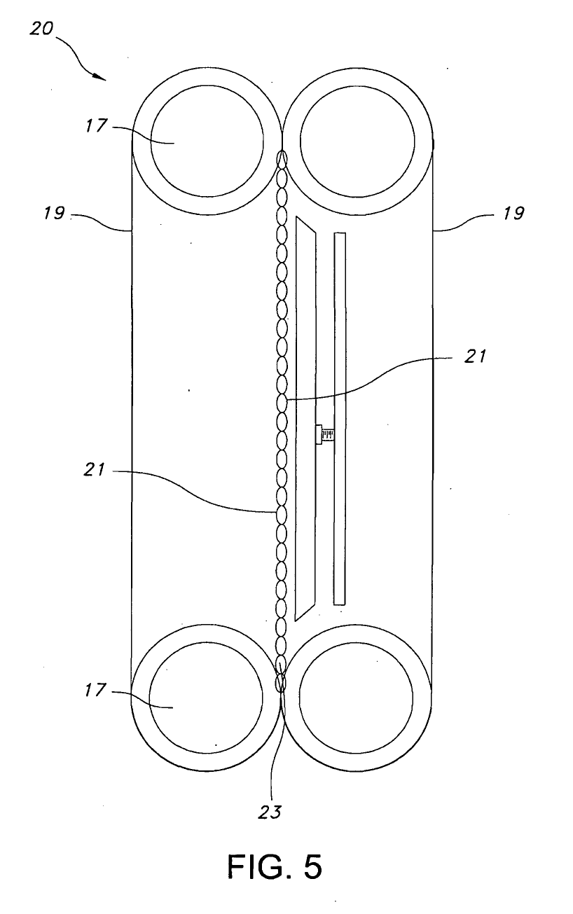

With reference to FIG. 5, generally the preferred cutting apparatus 20 includes a pair of continuous chains 19 placed facing opposite each other. The chains 19 include die halves 21. The chains 19 are rolled about the rollers 17 to bring a plurality of the die halves 21 together to form a plurality of longitudinally extended closed die cavities 23.

In one embodiment, the rope 14 may be fed from the relaxation conveyor 18 (FIG. 1) into the cutting apparatus 20 between the chains. An optional supplemental roller (not shown) located after the relaxation conveyor 18 may help feed the confectionery rope 14 into the cutting apparatus 20. This supplemental roller and cutting apparatus 20 should move the rope 14 at approximately the same velocity, to avoid bunching or tearing. The rope 14 may then be fed between the die halves 21 of the cutter, and fed through the cutter. The individual closed die cavity 23, which contains one piece of confectionery product, traverses from one end of the chain to the other, cutting and sealing the gum piece 22. Such sealing is important with a center-filled gum product so as to prevent release of the liquid center from the formed piece. The chain cutting apparatus 20 may contain any number of individual die cavities 23. A chain cutting apparatus 20 having multiple sets of dies may be incorporated, such that several ropes 14 of confectionery product may be simultaneously formed. As with the rope sizer 16 or the relaxation conveyor 18, the cutting apparatus 20 may optionally use an anti-sticking agent such as powder or oils or a cooling system, as described previously.

The confectionery products described herein may be manufactured by use of the extruder 12, rope sizer 16, relaxation conveyor 18, and chain cutting apparatus 20, or they may be manufactured by use of any combination of these elements, including by use of only one of the elements. Further, the methods and apparatus described herein may be used to manufacture any number of confectionery ropes simultaneously.

### Speed of the Rope Sizer, Relaxation Conveyor and Cutting Apparatus

With reference to FIGS. 1-4, the relative velocities of rope as it travels through the rope sizer 16, through the relaxation conveyor 18 and through the cutting apparatus 20 are all associated with and depend upon each other. If the rope 14 moves too quickly through the rope sizer 16 as compared to the velocity of the rope 14 through the relaxation conveyor 18 and/or through the cutting apparatus 20, the confectionery ropes 14 will not be fed into the cutting apparatus 20 quickly enough, resulting in bunching of the ropes 14, and eventual kinking and leakage of the center-filled composition. Likewise, if the rope 14 moves too slowly through the rope sizer 16 as compared to the velocity of the rope through the relaxation conveyor 18 and/or through cutting apparatus 20, the rope 14 will be fed too quickly into the cutter 20 or pulled too quickly along the conveyor 18, resulting in increased tension on the rope 14, and eventually the rope 14 breaking in half. Once the rope 14 is broken or cracked, leakage of the center-filled confectionery is likely to occur.

Thus, pursuant to the present invention, the relative velocities of the rope as it travels through the rope sizer 16, through the conveyor 18 and through the cutting apparatus 20 have a relationship relative to each other. The velocity differential between the rope 14 through the rope sizer 16 and the cutting apparatus 20 dictate the length of time needed for relaxation. The greater the differential, the greater the length of time delay, and vice versa. In a preferred embodiment, the rope 14 moves through the cutting apparatus 20 at about 100 m/min, to achieve a desired amount of finished, cut confectionery pieces 22.

As described herein, the rope sizer 16 includes several pairs of rope sizing rollers 24, each pair varies in speed, with the slowest roller pair being located at the entry point 24a of the confectionery rope 14, and the fastest roller pair being located at the exit point 24b of the confectionery rope 14. After the confectionery rope 14 leaves the rope sizer 16, it is deposited onto the relaxation conveyor 18, to allow for a time delay prior to being fed into the cutting apparatus 20. Thus, the speed of the rope sizing roller closest to the exit point of the confectionery rope, i.e., the pair of distal rollers 24b, plays the most important role with respect to the relative speeds of the other elements.

The rope sizer 16 passes the continuous rope 14 at a velocity faster than the velocity at which the rope is fed into the cutting apparatus 20, to allow for time delay to give a sufficient relaxation of the rope prior to being cut. The difference in the relative velocities of the rope traveling through the two determines the amount of time needed for the rope 14 to remain on the relaxation conveyor 18. Thus, if the rope 14 is fed into the cutting apparatus 20 at a velocity that is about 10 m/min slower than the velocity at which the rope 14 passes through the rope sizer 16, the time for relaxation on the conveyor 18 should be enough to compensate for the 10 m/min difference. Preferably, the fastest pair of rollers in the rope sizer 24b move the rope 14 at about 5% to about 300% faster than the velocity at which the rope 14 is fed into the cutting apparatus 20, and more specifically about 10% to about 20% faster than the velocity at which the rope 14 is fed into the cutting apparatus 20.

Preferably, the rope sizer 16 and cutting apparatus 20 are related by V_{rope sizer}>V_{cutting apparatus}; and A_{rope sizer}<A_{cutting apparatus}, where V is the velocity that the rope travels, and A is the cross sectional area of the rope. The rate of elongation between two rollers (E′₂₋₁) can be understood by the equation: E′₂₋₁=V₂−V₁. The total elongation between two rollers (E′₂₋₁) is understood by the equation: E₂₋₁=L₂/L₁=V₂/V₁, wherein L₁ is the unit of rope that is stretched at the first pair of rollers 24a in the rope sizer, L₂ is the unit of rope that is stretched in the rope sizer at the second pair of rollers 24b in the rope sizer, V₁ is the velocity of the rope between the extruder 12 and the first pair of rollers 24a in the rope sizer, and V₂ is the velocity of the rope between the first pair of rollers 24a in the rope sizer 16 and the second pair of rollers 24 in the rope sizer 16. Alternatively, V₂ and L₂ may be the velocity and unit of stretch, respectively, of the rope 14 in the cutting apparatus 20. The total elongation represents the amount of stretch per length of rope that entered the rope sizer 16. The rate of elongation between rollers 24 may be any desired rate from about 1 to about 30 m/min, and preferably is about 10-15 m/min. The total elongation between rollers 24 may be any elongation from about 1.1 to about 10, and more specifically about 1.5 to about 3. Thus, for every unit of length that is introduced into the rope sizer 16, the elongated rope that has been sized may be about 1.1 to about 10 times as long, and more specifically about 1.5 to about 3 times as long. Optionally, the rope 14 can be elongated more at the beginning of the rope sizer 16 than at the end, it may be elongated more at the end of the rope sizer 16 than at the beginning, or the rope 14 may be substantially uniformly elongated as it travels through the rope sizer 16.

The total elongation is determined by the total of the elongations as defined above, and is represented by the equation Eₜₒₜₐₗ=E₁₋₀×E₂₋₁×E₃₋₂× . . . E_{f-(f-1)}, and the total elongation rate E′ₜₒₜₐₗ=ΣE′ᵢ=E′₁₋₀+E′₂₋₁+E′₃₋₂+ . . . E_{f-(f-1)}, wherein f is the total number of pair of rollers 24 in the rope sizer 16. The relationship between the operating gaps and elongation is squared: Δgap˜(ΔE)². The specific gum elongation profile used greatly affects the propensity to shrinkage and seal failure. An ideal profile is the one that minimizes the amount of mechanical energy input. Elongation is controlled by the velocity of the rope as it travels though the individual components of the apparatus. The total elongation of the rope 14 according to the invention may be any elongation from about 1.1 to about 20, and more specifically about 1.5 to about 5.

What is claimed is:

1. An apparatus for preparing a center-filled consumable product comprising:
a. an extruder, which extrudes a continuous tubular rope of consumable product;
b. a rope sizer for reducing the diameter of said extruded continuous tubular rope;
c. a cutting apparatus for cutting said continuous rope into said consumable product; and
d. a relaxation conveyor for moving said rope from said rope sizer to said cutting apparatus.

2. The apparatus of claim 1, wherein said rope sizer includes a plurality of pairs of rollers aligned longitudinally for receipt of said tubular rope.

3. The apparatus of claim 2, wherein said rope sizer includes a first pair of rollers for accommodating said tubular rope, a last pair of rollers for permitting egress of said tubular rope, and at least one additional pair of rollers therebetween.

4. The apparatus of claim 3, wherein said last roller pair moves at a speed of rotation greater than the speed of rotation of said first roller pair.

5. The apparatus of claim 4, wherein the distance between said pairs of rollers decreases from said first pair of rollers to said last pair of rollers.

6. The apparatus of claim 1, wherein said relaxation conveyor includes a conveyor belt, said conveyor belt moving at a speed that is about 50% of the speed of the fastest roller in the rope sizer.

7. The apparatus of claim 1, wherein said relaxation conveyor further comprises a swing arm.

8. The apparatus of claim 7, wherein said swing arm oscillates to deposit the rope of consumable product onto said relaxation conveyor in a continuous wave pattern.

9. The apparatus of claim 1, wherein said cutting apparatus moves at a speed that is about 10% to about 20% slower than the fastest roller in the rope sizer.

10. The apparatus of claim 1, further comprising an injection port for filling said tubular rope of consumable product with a second consumable product.

11. The apparatus of claim 1, further comprising a means for applying an anti-sticking agent to at least one of the extruder, the rope sizer, the cutting apparatus, the relaxation conveyor, or the rope.

12. The apparatus of claim 11, wherein said anti-sticking agent is a powder or an oil.

13. A method of forming a center fill consumable product comprising the steps of:
a. extruding a continuous tubular rope of said consumable product;
b. reducing the diameter of said extruded continuous tubular rope;
c. transporting said reduced diameter extruded rope along a movable relaxation conveyor; and
d. cutting said extruded continuous rope into individual pieces of said consumable product.

14. The method of claim 13, wherein said step of reducing the diameter further includes providing a rope sizer, said rope sizer including a first pair of rollers for accommodating entry of said extruded tubular rope, and a last pair of rollers for permitting egress of said extruded tubular rope, and at least one pair of rollers therebetween.

15. The method of claim 14, wherein said step of reducing the diameter further includes mutually rotating each said pair of rollers at different speeds.

16. The method of claim 15, wherein said step of reducing the diameter further includes mutually rotating said last pair of rollers at a faster speed than the speed of rotation of said first pair of rollers.

17. The method of claim 16, wherein said transporting step includes moving said relaxation conveyor at a speed about 50% of the speed of the last roller pair.

18. The method of claim 13, further including the step of depositing the rope of consumable product onto said relaxation conveyor in the shape of a continuous wave.

19. The method of claim 18 wherein said depositing step further includes the steps of:
a. providing a swing arm for accommodating said rope; and
b. oscillating said swing arm.

20. The method of claim 13, further comprising the step of applying an anti-sticking agent to the rope prior to said reducing step.

21. The method of claim 20, wherein said anti-sticking agent is a powder or an oil.

22. A method for forming a center-filled consumable product comprising the steps of:
a. extruding a continuous tubular rope of said consumable product;
b. passing said extruded rope through a rope sizer; and
c. passing said rope into a cutting apparatus, wherein the cutting apparatus cuts the rope into individual pieces.

23. The method of claim 22, wherein said rope sizer includes a plurality of pairs of rollers aligned longitudinally for receipt of said tubular rope.

24. The method of claim 23, wherein said rope sizer includes a first pair of rollers for accommodating said tubular rope, a last pair of rollers for permitting egress of said tubular rope, and at least one additional pair of rollers therebetween.

25. The method of claim 24, wherein each of said roller pairs rotate at different speeds.

26. The method of claim 25, wherein said last roller pair moves at a speed of rotation greater than the speed of rotation of said first roller pair.

27. The method of claim 26, wherein said cutting apparatus moves at a speed that is about 10% to about 20% slower than the fastest roller in the rope sizer.

28. The method of claim 22, further comprising an injection port for filling said tubular rope of consumable product with a second consumable product.

29. A method for forming a center-filled consumable product comprising the steps of:
a. extruding a continuous tubular rope of said consumable product;
b. passing said rope along a relaxation conveyor; and
c. passing said rope into a cutting apparatus, wherein the cutting apparatus cuts the rope into individual pieces.

30. The method of claim 29, wherein said relaxation conveyor includes a conveyor belt, said conveyor belt moving at a speed that is about 50% of the speed at which said tubular rope is extruded.

31. The method of claim 29, wherein said relaxation conveyor further comprises a swing arm.

32. The method of claim 31, wherein said swing arm oscillates to deposit the rope of consumable product onto said relaxation conveyor in a continuous wave pattern.

33. The method of claim 29, further comprising an injection port for filling said tubular rope of consumable product with a second consumable product.

34. An apparatus for preparing a center-filled consumable product comprising a rope sizing apparatus comprising a plurality of pairs of rollers aligned longitudinally for receipt of said center-filled consumable product, wherein said rope sizer includes a first pair of rollers for accommodating said center-filled consumable product, a last pair of rollers for permitting egress of said center-filled consumable product, and at least one additional pair of rollers therebetween, and wherein said last roller pair moves at a speed of rotation greater than the speed of rotation of said first roller pair.

35. The apparatus of claim 34 wherein said roller pairs include grooved surfaces for accepting said center-filled consumable product.

36. The apparatus of claim 34, wherein the distance between said pairs of rollers decreases from said first pair of rollers to said last pair of rollers.

37. The apparatus of claim 34, wherein said pairs of rollers move said center-filled consumable product at velocities from about 10 m/min to about 125 m/min.

38. The apparatus of claim 34, wherein said rope sizer reduces the thickness of said center-filled consumable product by about 30% to about 70%.

39. The apparatus of claim 34, further comprising a means for applying an anti-sticking agent to at least one of said rope sizer or said center-filled consumable product.

40. The apparatus of claim 39, wherein said anti-sticking agent is a powder or an oil.

41. An apparatus for preparing a center-filled consumable product comprising a relaxation conveyor for moving said center-filled consumable product.

42. The apparatus of claim 41, wherein said relaxation conveyor further comprises a swing arm.

43. The apparatus of claim 42, wherein said swing arm oscillates to deposit the center-filled consumable product onto said relaxation conveyor in a continuous wave pattern.

44. The apparatus of claim 41, further comprising a means for applying an anti-sticking agent to at least one of said relaxation conveyor or said center-filled consumable product.

45. The apparatus of claim 44, wherein said anti-sticking agent is a powder or an oil.
